(19) United States
(12) Patent Application Publication
(10) Pub. No.: US 2026/0012060 A1
(43) Pub. Date: Jan. 8, 2026

(54) PLANETARY GEARING SYSTEM

(71) Applicant: PHOS GLOBAL ENERGY SOLUTIONS, INC., Fort Lauderdale, FL (US)

(72) Inventors: Victor Bica, Saint James, NY (US); Eugene Earle Rudolph, Port Jefferson Station, NY (US)

(73) Assignee: PHOS GLOBAL ENERGY SOLUTIONS, INC., Fort Lauderdale, FL (US)

(21) Appl. No.: 18/993,429

(22) PCT Filed: Jul. 11, 2023
(86) PCT No.: PCT/US2023/027358

§ 371 Date: Jan. 10, 2025

Related U.S. Application Data
(60) Provisional application No. 63/388,221, filed on Jul. 11, 2022.

(51) Int. Cl. H02K 7/18; F03G 3/08; F16C 32/04; H02K 7/02

(52) U.S. Cl. CPC H02K 7/1823; F03G 3/08; F16C 32/044; H02K 7/025

(57) ABSTRACT

A renewable energy generation system including a flywheel assembly having a flywheel configured for mechanical storage of energy, a magnetic planetary gear set coupled to the flywheel assembly, a motor operably connected to a magnetic motor gear, wherein the magnetic motor gear magnetically couples with a ring gear of the magnetic planetary gear set to drive the flywheel and convert electrical energy driving the motor into the mechanical energy stored in the flywheel.

### CROSS-REFERENCE TO RELATED APPLICATIONS

The instant application is a National Phase application of PCT/US2023/027358 dated Jul. 11, 2023, which claims priority to U.S. Provisional Application No. 63/388,221 filed Jul. 11, 2022, bearing the title PLANETARY GEARING SYSTEM (GEARBOX FOR FLYWHEEL APPLICATION) Further, this application is related to Patent Cooperation Treaty Application No. WO 2021/096470 filed Aug. 14, 2020, and PCT/US2022/029255 filed May 13, 2022, the entire contents of which are incorporated herein as if set forth fully particularly the descriptions of flywheels and their various uses for storage and allocation of energy on demand.

### TECHNICAL FIELD

This disclosure relates generally to renewable energy devices, and in particular to mechanical renewable energy generation and storage devices and magnetic planetary gear systems employable therewith.

### BACKGROUND

Renewable energy has become an increasingly important source of electrical energy generation in many countries around the world. As the demand for electrical energy has increased, the impact of fossil fuels on the environment has become magnified and increasingly apparent. In an effort to overcome these obstacles, advancements in green energy generation have continued to accelerate, resulting in innovations such as hydrodynamic generators, wind turbines, geothermal energy, biomass energy, amongst others. However, mechanical energy storage and generation, despite its simplicity, has historically remained rather undeveloped. In traditional mechanical systems, as a load is placed upon the system, the mechanical device driving electrical generators loses momentum, resulting in a drop in electrical energy generation. To avoid this decrease in electrical energy generation, it is necessary to input additional energy to maintain consistency and therefore provide consistent electrical energy generation. As can be appreciated, the constant increase or decrease in energy required to maintain constant electrical energy generation using traditional mechanical systems is inefficient and wasteful.

### SUMMARY

One aspect of the disclosure is directed to a renewable energy generation system including includes a flywheel assembly having a flywheel configured for mechanical storage of energy; a magnetic planetary gear set coupled to the flywheel assembly; a motor operably connected to a magnetic motor gear, where the magnetic motor gear magnetically couples with a ring gear of the magnetic planetary gear set to drive the flywheel and convert electrical energy driving the motor into mechanical energy for storage in the flywheel.

Implementations of this aspect of the disclosure may include one or more of the following features. The renewable energy generation system where the magnetic planetary gear set further includes at least one planet gear magnetically coupled to the ring gear. The magnetic planetary gear set further includes a sun gear magnetically coupled to the planet gear. Each of the ring gear, at least one planet gear, and sun gear include two rows of magnets. The sun gear further includes a magnetic lift bearing lifting the sun gear in a direction of a top plate of the ring gear to reduce a vertical load on the sun gear. The magnetic lift bearing includes a magnetic ring affixed to the sun gear and attracting the sun gear towards the top plate of the ring gear. The sun gear further includes at least one mechanical bearing, and where the magnetic lift bearing reduces a vertical load on the mechanical bearing. The at least one planet gear further includes a magnetic levitating bearing lifting the planet gear away from a bottom plate of the planetary gear set to reduce a vertical load on the planetary gear. The magnetic levitating bearing includes a first magnetic ring secured to a shaft about which the at least one planet gear rotates and a second magnetic ring secured to the planet gear. The first and second magnetic rings have a common polarity facing one another such that the first and second magnetic rings repel one another and lift the at least one planet gear relative to the shaft. The at least one planet gear further includes at least one mechanical bearing, and where the magnetic levitation bearing reduces a vertical load on the mechanical bearing. The ring gear further includes a magnetic lift bearing lifting the ring gear in a direction of a top plate of the planetary gear set to reduce a vertical load on the sun gear. The magnetic lift bearing includes two magnets arranged to attract each other. The renewable energy generation system where a first of the two magnets is secured to a shaft of the ring gear and a second of the two magnets is secured to a cover enclosing the shaft, the cover configured to mate with a top plate of the planetary gear set. The shaft extends from a spindle configured to mate with a top plate of the ring gear. The ring gear further includes at least one mechanical bearing mounted on the shaft extending from the spindle, and where the magnetic lift bearing reduces a vertical load on the mechanical bearing. The magnetic generator gear magnetically couples with one of the ring gear or the motor gear. The planetary gear set includes a plurality of transfer points, where each transfer point enables magnetic coupling of the ring gear with the motor gear or a generator gear.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiments given below, serve to explain the principles of the disclosure, wherein:

FIG. 1 is a perspective view of a renewable energy generation system provided in accordance with the present disclosure;

FIG. 2 is a top view of a flywheel assembly of the renewable energy generation system of FIG. 1;

FIG. 3 is an end view of a flywheel assembly of the renewable energy generation system of FIG. 1;

FIG. 4 is a top view of a planetary gear set in accordance with the disclosure;

FIG. 5 is a perspective view of the planetary gear set of FIG. 4;

FIG. 6 is a cross-sectional view of a planetary gear set in accordance with the disclosure;

FIG. 7 is a second cross-sectional view of a planetary gear set in accordance with the disclosure;

FIG. 8 is a cross-sectional view of a ring gear in accordance with the disclosure;

FIG. 9 is a cross-sectional view of a sun gear set in accordance with the disclosure;

FIG. 10 is cross-sectional view of a planet gear in accordance with the disclosure;

FIG. 11 is a perspective view of a planet gear in accordance with the disclosure; and

FIG. 12 is a perspective vie of a renewable energy generation system in accordance with the disclosure.

### DETAILED DESCRIPTION

Embodiments of the disclosure are now described in detail with reference to the drawings in which like reference numerals designate identical or corresponding elements in each of the several views. In the drawings and in the description that follows, terms such as front, rear, upper, lower, top, bottom, and similar directional terms are used simply for convenience of description and are not intended to limit the disclosure. In the following description, well-known functions or constructions are not described in detail to avoid obscuring the present disclosure in unnecessary detail.

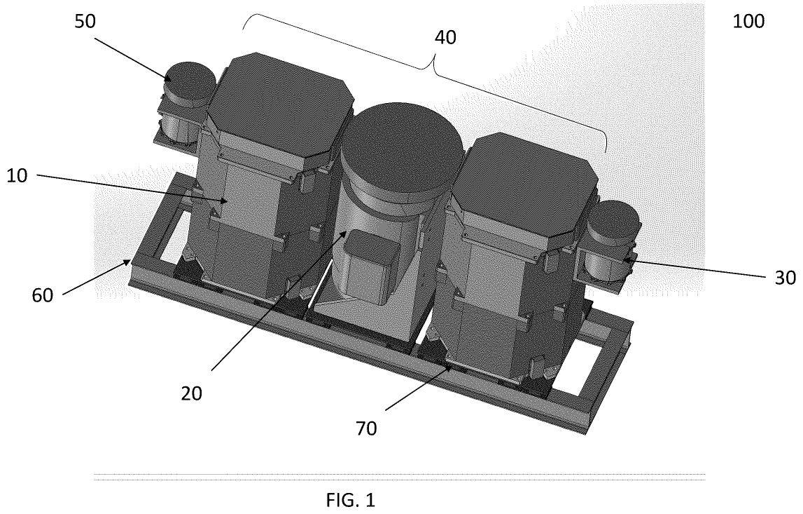

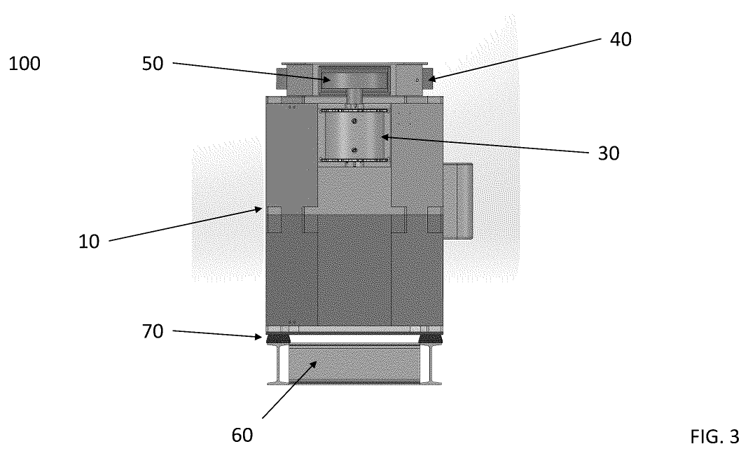

Referring now to the drawings, a renewable energy generation system is illustrated in FIGS. 1-3 and generally identified by reference numeral 100. The renewable energy generation system 100 includes one or more flywheel assemblies 10, one or more motors 20, and one or more generators 30. A gear train 40 extends across the flywheel assemblies 10 and motor 20, and drives a gear 50 connected to the generator 30.

The renewable energy generation system 100 may be mounted on a frame 60, via mounts 70 to absorb vibrations associated with the rotating machinery. Details of flywheel assembly 10 and the renewable energy generation generally can be found in commonly assigned and co-pending PCT application XXXX titled MECHANICAL RENEWABLE GREEN ENERGY PRODUCTION, filed concurrently herewith the entire contents of which is incorporated herein, and particularly the disclosure related to the flywheels and their magnetic bearings. As described therein, the motor 20 may be an alternating current (AC) or direct current (DC) motor and connected to any source of electrical energy including one or more of the electrical mains, a natural gas or diesel generator, an array of photovoltaic solar panels, and wind turbine generator(s) to power the motor 20. Via the gear train 40, the rotational energy output from the motor 20 is passed to the flywheel assemblies 10.

As described hereinbelow, the gear train 40 allows the motor 20 to rotate at one speed (e.g., 1800, 3600, RPM or another desired speed) and causes the flywheel mounted within the flywheel assembly 10 to rotate at between 5000 and 15,000 RPM. The weight of the flywheel rotating at high speeds (e.g., 10,000 RPM) stores the electrical used to spin the motor as mechanical energy. The flywheel is a mechanical battery. In at least one aspect of the disclosure the flywheel within each flywheel housing stores between 5 and 50 kWh of energy, in some examples each flywheel stores 25 kWh of energy.

The generator 30, which is connected to the gear train 40 via a generator gear 50. The gear train 40 causes the gear 50, and therewith the generator 30 to spin. When a n electrical load is placed on the generator 30, either directly or indirectly, energy from the flywheel in the flywheel assembly 10 is converted to useable electrical energy and supplied to the load.

A variety of use cases have been conceived for the flywheel assemblies 10 including as emergency back-up energy storage and production in cases of blackouts or other service interruptions, as an energy storage and distribution system for remote operations (e.g., forward deployment of military or emergency services) to reduce reliance on diesel generators, as energy storage for the grid useable for peak demand times, energy storage for industrial facilities and buildings to undertake peak shaving, and others without departing from the scope of the disclosure.

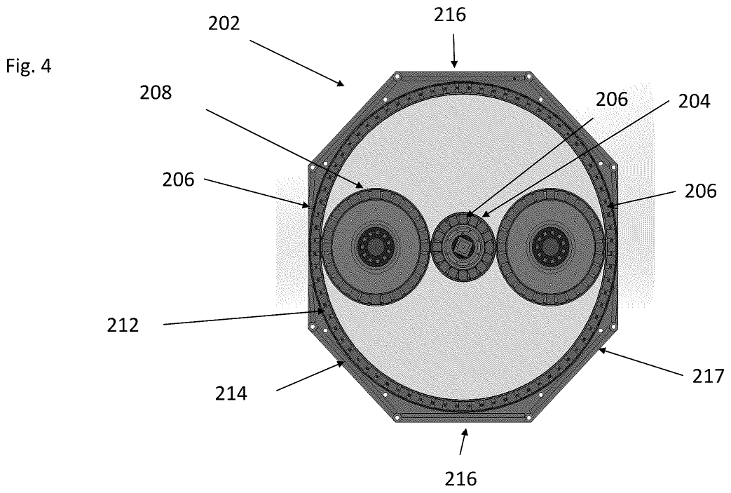

This disclosure is in part directed to systems and methods to efficiently transfer energy from the motor 20 to the generator 30 with limited losses. Specifically, this disclosure is directed in part to the details of the gear train 40. The gear train 40 is comprised of a motor gear 200 and one or more planetary gear sets 202. Top view of a portion of a planetary gear set 202, is depicted in FIG. 4. The planetary gear set 202 is comprised of a sun gear 204 which mounts, either directly or indirectly to a shaft operably connected to a flywheel of a flywheel assembly 10, as described in greater detail below. The sun gear 204 includes a plurality of magnets 206 mounted on an exterior portion of the sun gear 204. The magnets 206 on the sun gear 204 magnetically couple with magnets 206 formed on an exterior portion of a planet gear 208. Each planet gear 208 is supported by and spins on its own shaft 210. As will be appreciated, the planet gears 208 rotate in the opposite direction of the sun gear 204, thus where the sun gear 204 rotates clockwise, the planet gears 208 will rotate counter clockwise. Further, unlike some traditional planetary gear systems, each planet gear 208 does not rotate about the sun gear 204, but rather is mounted to its shaft 210 in fixed relationship with the sun gear 204. Though shown here with two planet gears 208, other configurations (e.g., four, 6, 8, 10 planet gears) may be employed without departing from the scope of the disclosure.

The magnets 206 of the planet gear 208 engage with magnets 206 of a ring gear 212. Again as will be appreciated the interaction of the magnets of the planet gear 208 and the magnets 206 of the ring gear 212 will cause the ring gear to rotate in the opposite direction as the planet gear 208 and in the same direction as the sun gear 204. Because the planet gears 208 are symmetrical with respect to the ring gear 212, the forces applied to the ring gear 212 are generally balanced, and thus the transverse stresses that could otherwise stress the shaft of the operably connected to the flywheel in the flywheel assembly or other components of the system 100 is reduced.

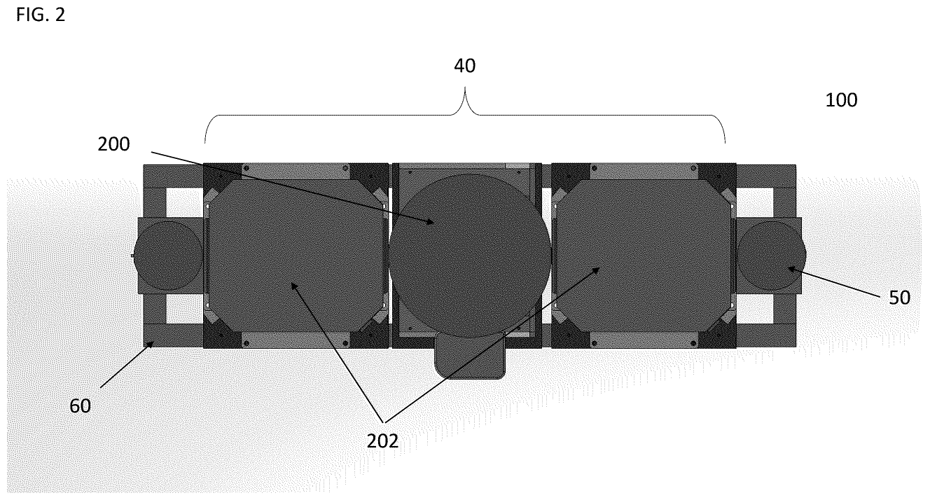

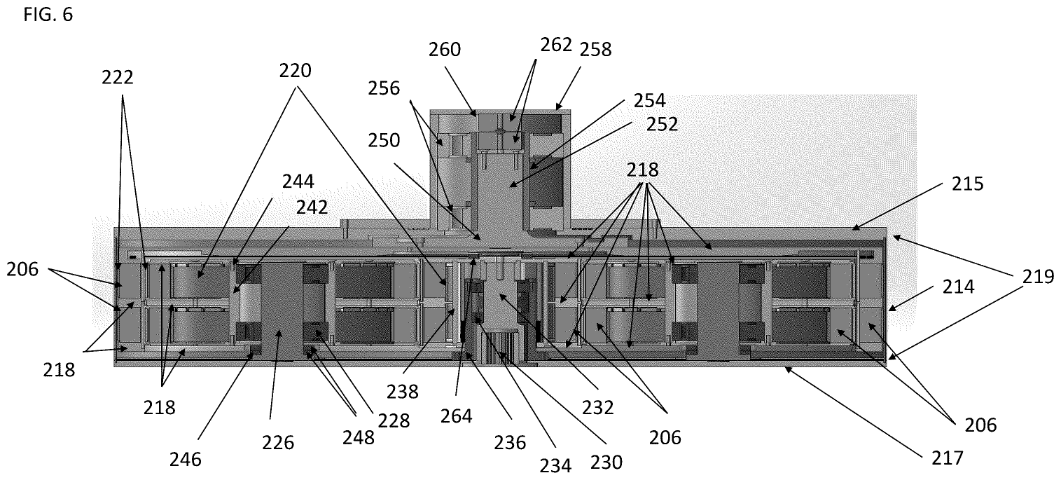

A gearbox wall 214 surrounds the ring gear 212 and mates with a top plate 215 (FIG. 6) and a bottom plate 217 includes a seal 219 (FIG. 6) that enables the formation of an airtight seal around the gears of the planetary gear set 202. The seal 219 allows a vacuum to be drawn on the planetary gear set 202 to remove air within the gearbox wall 214. The vacuum reduces or eliminates much of the windage and friction of the caused by the spinning of components of planetary gear set 202. As shown in FIG. 4, the gearbox wall 214 is in this instances is octagonal, with each facet of the octagon forming a transfer point 216 where the ring gear 212, and specifically the magnets 206 of the ring gear 212, comes in close proximity to the gear box wall 214, and can magnetically engage with magnets of another gear such a motor gear 200 (FIG. 2) or the generator gear 50. Though shown with eight transfer points 216, the gear box wall 214 may take on another shape (e.g., square) and have just four transfer points 216.

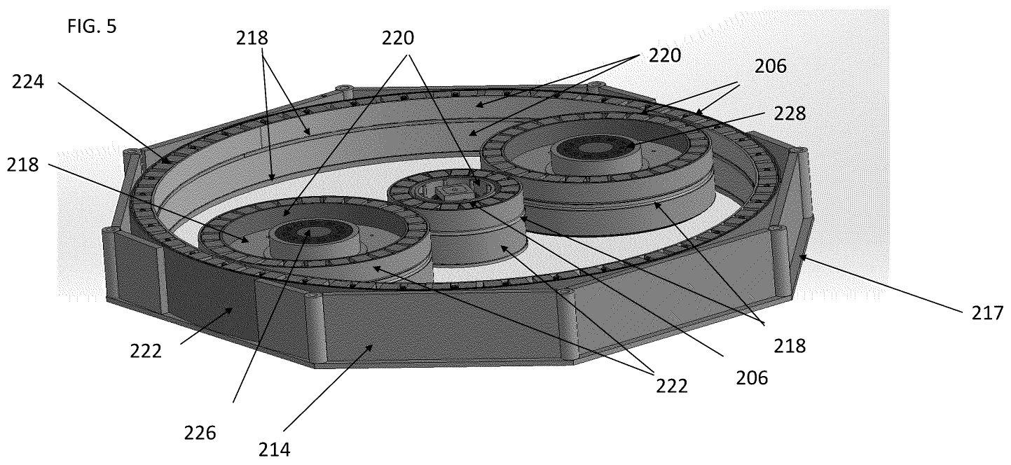

FIG. 5 depicts a perspective view of the portion of the planetary gear 202 depicted in FIG. 4. As depicted in FIG. 5, the gears of the planetary gear 202 include double rows of magnets 206, one on top of the other. Described in greater detail below, each gear, for example, the planet gear 208 includes metal plates 218 to which the magnets 206 are mounted. Each gear, for example the planet gear 208 includes an outer ring 222, for example a carbon fiber, but in any even non-ferrous thus non-magnetic material to prevent the radial movement of the magnets 206. In addition, each gear, for example the planet gear 208 includes an inner ring 220. Thus, the magnets 206 are housed between the inner ring 220 and the outer ring 222 to prevent the movement of the magnets 206. The magnets 206 may be secured to the metal plates 218 via mechanical fasteners or chemical fasteners such as adhesives or epoxy. In addition, a non-conductive fastener 224 secures the magnets 206 to each other and to the inner ring 220 and the outer ring 222.

As noted above, each of the planet gears 208 is mounted on a shaft 226. The metal plates 218 and the magnets 206 rotate about the shaft 226 on bearings 228, such as ball bearings or roller bearings. As will be described in greater detail below, in addition to mechanical bearings 228, each gear may optionally include a magnetic lift or magnetic levitation bearing.

FIG. 6 depicts a cross-sectional view of the planetary gear set 202 showing the interaction and placement of the sun gear 204, the planet gears 208 and the ring gear 212. A spline 230 is machined into the shaft 232 of the sun gear 204. This spline is configured to mate with a shaft extending from the flywheel assembly 10 to mechanically couple the sun gear 204 with the flywheel, thus the flywheel and the sun gear rotate at the same speed. Mechanical bearings 234 (e.g., ball bearings or roller bearings) are fit to the shaft 232. The shaft 232 and mechanical bearings 234 are received in a bearing mount 236, and the shaft 232 rotates relative to the stationary bearing mount 236 (further details below). Through bolts or fasteners 238 connect the plates 218 of the sun gear 204, and secure the magnets 206, the outer ring 222 and the and inner ring 220 together to form the sun gear 204, which is spins on the mechanical bearings 234 relative the bearing mount 236 at the same speed as the flywheel connected thereto via the spline 230.

As can be seen in FIG. 6, each gear includes two rows of magnets 206. Though the disclosure is not so limited, and one or more of the gears may include a single row of magnets 206 for engaging its neighboring gears. Each row of magnets 206 may have the magnets arranged such that the polarity of the magnet facing outward (e.g., away from shaft 232) alternates from one magnet 206 to the next (e.g., N-S-N-S) around the circumference of the gear to be attracted a similar alternating arrangement of magnets on a neighboring gear. This alternating of polarities helps prevent cogging or slipping of one gear relative to the neighboring gears and promotes efficient transfer of motion from one gear to the next. Alternatively, all of the magnets 206 of a top ring of a first ger (e.g., the sun gear) can have an outward facing polarity that is N while a top ring of a neighboring gear (e.g., the planet gear) can have an outward facing polarity that is S. To balance the magnetic forces, the bottom rings of the two gears can have the opposite orientations (e.g., S on the sun gear and N on the planet gear). Other arrangements of the magnets 206 may also be employed without departing from the scope of the disclosure.

Using one of the arrangements described above, the magnetically coupled (i.e., via magnetic attraction) by magnets 206 of the sun gear 204 are the magnets 206 of the planet gear 208. The shaft 226, that may optionally be formed of aluminum or another non-ferrous or non-magnetic material, is secured to a bottom plate 217 of the planetary gear set 202. The use of aluminum may be beneficial for the removal of heat that can be generated by eddy currents created by the interaction of the magnetic fields of the magnets 206 of neighboring gears. The mechanical bearings 228 are fit to the shaft 226 and a bushing 242 forming an inner surface of the planet gear 208 is fitted to the mechanical bearings 228 such that the bushing 242 and planet gear 208 rotates freely about the shaft 226 on the mechanical bearings 228 The metal plates 218 of the planet gear 208 are secured to the bushing 242 with fasteners 244 to sandwich the outer ring 222 and inner ring 220, along with the magnets 206 therebetween.

A magnetic lift bearing 246, formed of two magnetic rings 248, one secured to the bottom plate 240 and one secured to the shaft 226 may be optionally employed. The magnetic polarities of the two magnetic rings 248 are arranged such that the same polarities face one another. For example, a magnetic ring 248 on the shaft 226 may have its upward facing polarity be N and similarly the downward facing polarity of the magnetic ring 248 secured to the bottom plate 240 is also N. In this way the two magnetic rings 248 repel each other, and therewith force the planet gear 208 away from the bottom plate 240 levitating the planet gear and forming a gap between the two magnetic rings 248. The levitation of the planet gear further reduces friction in the planetary gear set 202 by substantially eliminating any vertical load or weight that must be borne by the mechanical bearings 228. Such a reduction increases the life span of the mechanical bearings 228 and reduces any needed maintenance.

The ring gear 212 in FIG. 6 also includes two rows of magnets 206 secured between an outer ring 222 and an inner ring 220. Like the other bearings in FIG. 6, three metal plates 218 and non-conductive fasteners 224 (FIG. 5) are used to sandwich the components together forming the ring gear 212. Of note the top metal plate 218 of the ring gear spans the entire diameter of the planetary gear set 202, such that the planet gears 208 and the sun gear 204 are within the circumference of the ring gear 212. Secured to the top metal plate 218 is a spindle 250. The spindle 250 extends vertically upward forming a shaft 252 that passes through the top plate 215 of the planetary gear set 202. The shaft 252 is received in and press fits with a bushing 254. Secured to an outer diameter of the bushing 254 are mechanical bearings 256 (e.g., ball bearings or roller bearings). An outer race of the mechanical bearings 256 is fit to a cover 258 secured to the top plate 215, such that the spindle 250 spins relative to the cover 258 and top plate 215. At a top portion of the shaft 252 is a magnetic lift bearing 260. The magnetic lift bearing 260 is formed of two magnets, or two sets of magnets 262. A first magnet 262 is secured to the top of the shaft 252 and a second magnet 262 is secured to the cover 258. The polarities of the two magnets of the magnetic lift bearing 260 are opposite of one another such that the two magnets 262 are attracted to each other. The attraction of the two magnets 262 lifts the spindle 250 and therewith the ring gear 212 and reduces or eliminates the vertical load caused by the weight of the ring gear 212 on the mechanical bearings 256. The magnetic lift bearing 260 substantially transfers the weight of the ring gear 212 to the cover 258 and the top plate 215 and therewith to the flywheel assembly 10 and the frame 60.

On a top metal plate 218 of the sun gear 204 is another magnetic ring 264. The magnetic ring 264 is configured to be attracted to the top metal plate 218 of the ring gear 212. As noted above, the top metal plate 218 of the ring gear 212 is formed of a steel material such that the magnetic ring 264, secured to the top metal plate 218 of the sun gear 204, is lifted magnetically in the direction of the top metal plate 218 of the ring gear 212. As with the other magnetic lift or magnetic levitation bearings described herein, the magnetic attraction of the magnetic ring 264 reduces or eliminates the vertical load of the sun gear 204 on the mechanical bearings 234 of the sun gear 204. By incorporating all three magnetic lift and magnetic levitating bearings within the planetary gear set 202, the mechanical bearings described herein should have little to no vertical load, and thus their maintenance reduced and their life spans increased. In addition, the overall efficiency of the planetary gear set 202 is greatly increased. Further, though described here as being mounted on the top metal plate 218 of the sun gear 204, the magnetic lift bearing 264 could also be formed on the underside of the top metal plate 218 of the ring gear 212 to achieve the same desired effect without departing from the scope of the disclosure.

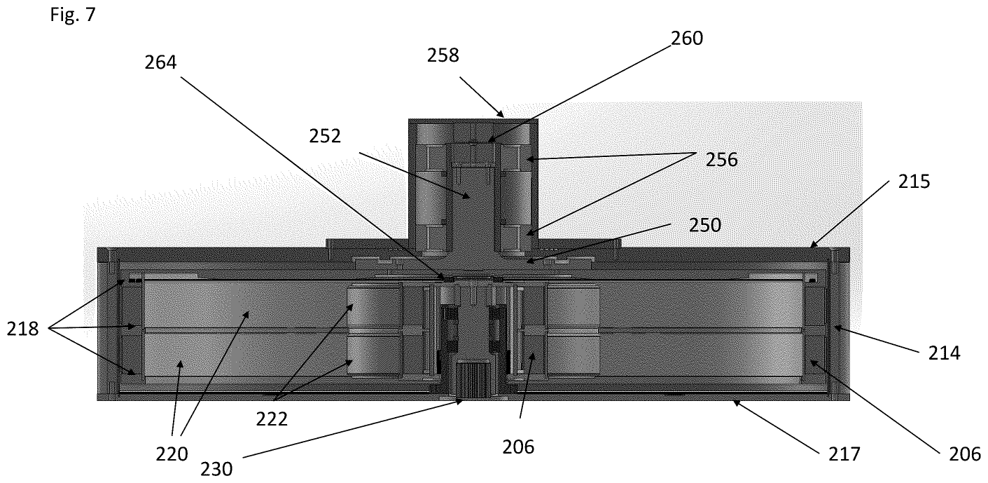

FIG. 7 is another cross-sectional view of the planetary gear set 202. In FIG. 7, the cross-section is 90 degrees from the cross section in FIG. 6, thus only a small portion of the outer rings 222 of the planet gears 208 are visible in this view. This view shows the relationship of the ring gear 212 and the sun gear 204 via the magnetic lifting bearing 264. One feature that is easier to observe in FIG. 7 are the spaces between the top plate 215 and the top metal plate 218 of the ring gear, as well as the spaces between the bottoms of the gears and the bottom plate 217.

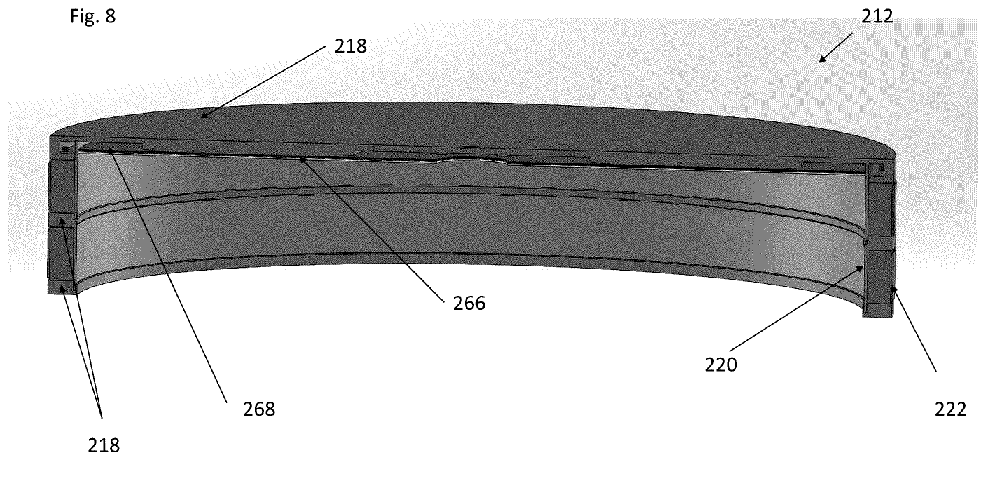

FIG. 8 depicts a cross-section of the ring gear 212. Though not observable in other views, the ring gear 212 may include a non-conductive plate 266 on the underside of the top plate 218, which reduces the attraction of any of the magnets 206 of the gears with the top metal plate 218. In addition between the top metal plate 218 and the non-conductive plate 266 may be one or more layers of magnetic shielding 268 which may reduce the inducement of eddy currents in the metal top plate 218 and other steel or ferrous components of the planetary gear set 202.

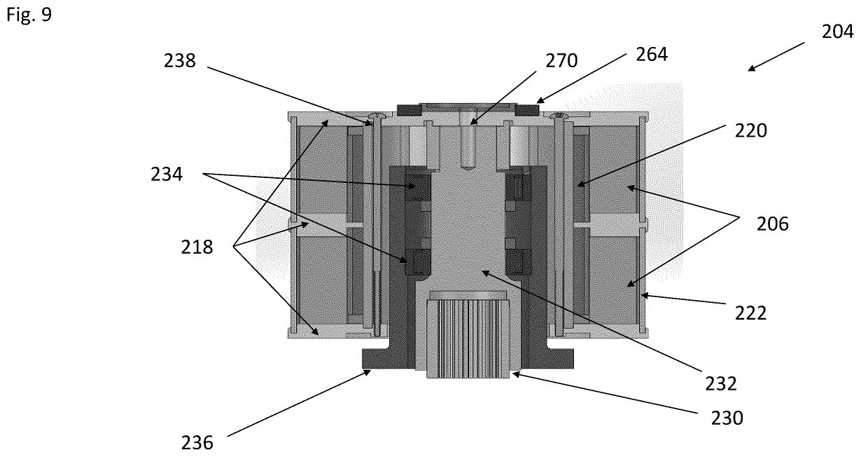

FIG. 9 depicts a detailed cross section of the sun gear 204 One aspect visible in FIG. 9 and not other views are the notches formed on the metal plates 218 configured to receive the inner ring 220 and the outer ring 222. In addition, though fasteners 238 are employed to sandwich the metal plates 218 and magnets together, a torque bolt or other fastener 270 can be employed to secure the top metal plate 218 to the shaft 232 and therewith transfer the mechanical load from the sun gear 204 to the flywheel via the spline 230.

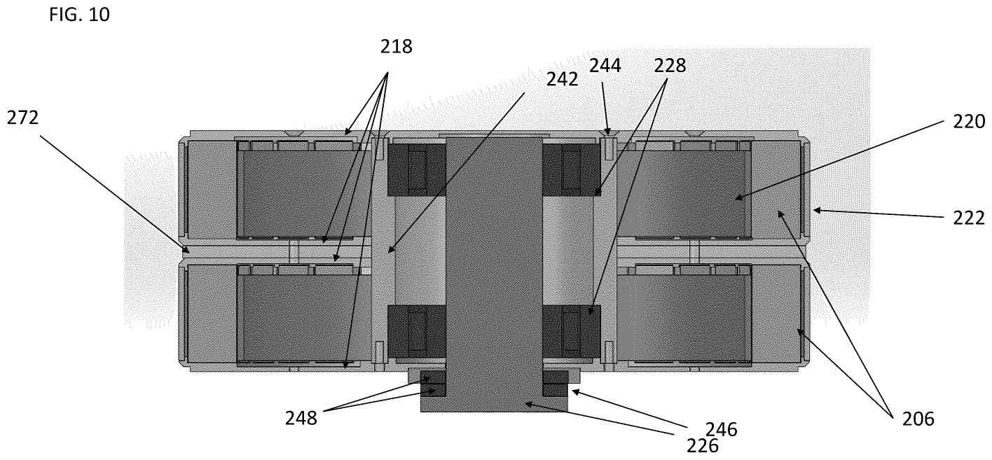

FIG. 10 depicts a detailed cross section of the planet gear 208. One feature not viewable in other images of the planet gear is a non-conductive spacer 272 between two metal plates 218. The non-conductive spacer 272 limits interaction between magnets 206 of a top row of a neighboring gear from interacting with magnets 206 of the bottom row of the planet gear 208, and from the top row of the planet gear 208 from interacting with a bottom row of magnets 206 of a neighboring gear. The non-conductive spacer 272 also limits eddy currents that can be formed by the rotation of the magnets 206 relative to each other and also in other magnetic, ferrous, or conductive components of the planetary gear set 202.

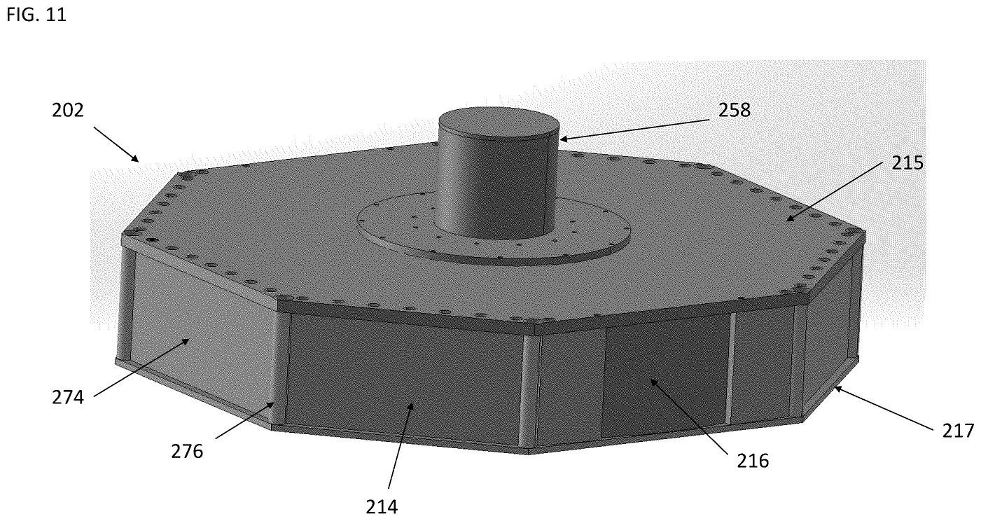

FIG. 11 depicts an exterior view of the planetary gear box 202. The top cover 258 is supported by and secured to the top plate 215. The bottom plate 217 forms a bottom of the planetary gear box enabling securing of the planetary gear box 202 to a flywheel assembly 10. The gear box wall 214 may be formed of a series of non-conductive walls 274 and non-conductive support columns 276. These use of the support columns 276 and the walls 274 reduces the machining costs of the gear box wall 214. Of course a single piece gear box wall is also contemplated within the scope of the disclosure. The support columns 276 and the walls 274 may be secured to each other with adhesives such as epoxy and machined to receive one or more fasteners to secure the top plate 25 and the bottom plate 217 thereto. In FIG. 11 the transfer point 216 is shown shaded. The transfer point 216 may be formed of the same material as the gear box wall 214, or may employe a thinner material to allow the magnetic fields of the ring gear 212 to better interact with magnetic fields of the motor gear 200 or the generator gear 50. Though shown on just once facet of the octagon forming the planetary gear set 202, the transfer point 216 may be on any facet and on multiple facets depending on the configuration of the renewable energy generation system 100.

Though not explicitly shown, the motor gear 200, which is coupled to the motor 20, is substantially similar in construction to the ring gear 212. The primary difference is that the motor gear 200 has a coupling, similar to spindle 250 enabling the motor gear to be secured to and driven by the shaft of the motor 20. The magnet 206 arrangement and other aspects are nearly identical. In this way the ring gear 212 can be driven a motor speeds (e.g., 1800, 3600, or a custom RPM) that does not overly stress the components of the motor gear 200 or the ring gear 212. The planetary system described herein above in connection with planetary gear set 202 enables the sun gear 204 to be driven at some multiple of the motor speed. The gear ratio may be 3-1, 4-1, 4.5-1, 4.75-1, 5-1 up to about 10-1. Thus, if the motor 20 were driven at 1500 RPM and the gear ratio was 5-1 the sun gear 204 and flywheel would be driven at about 7500 RPM.

Using the planetary gear set 202 described herein, the high speeds of the flywheel can be achieved with very little if any friction or losses caused by the gearing. The use of magnetic gears eliminates all sliding friction between the gears, and the use of the magnetic lift or magnetic levitating bearings further eliminates most of the friction associated with the weight of the individual gears of the planetary gear set 202. Finally, by having the planetary gear set 202 under a vacuum, substantially all windage and other losses associated with rotating equipment is further eliminated. The result is that a renewable energy generation system 100 employing the planetary gear set 202 can achieve a round trip efficiency (energy into the motor vs energy out of the generator) in excess of 90-95%.

As shown herein above, the renewable energy generation system 100 includes a central motor 20 driving a motor gear 200 and two flywheel assemblies 10 each of which have a planetary gear set 202. Each planetary gear set 202 in turn drives a generator gear 50. However, the disclosure is not so limited. The generator gears 50 and generators 30 may be placed such that the generator gears 50 engage the motor gear 200 rather than the ring gear 212 of the planetary gear set 202 on the flywheel assemblies 10. Such a configuration may limit the overall length of the renewable energy generation system 100 without significantly increasing its width.

In a further configuration each of the motor 20 and flywheel assemblies 10 may include a planetary gear set 202. Again, the generator gear 50 may be located on the ends as shown in FIG. 1, or proximate a transfer point 216 on the planetary gear set 202 mounted on the motor 20.

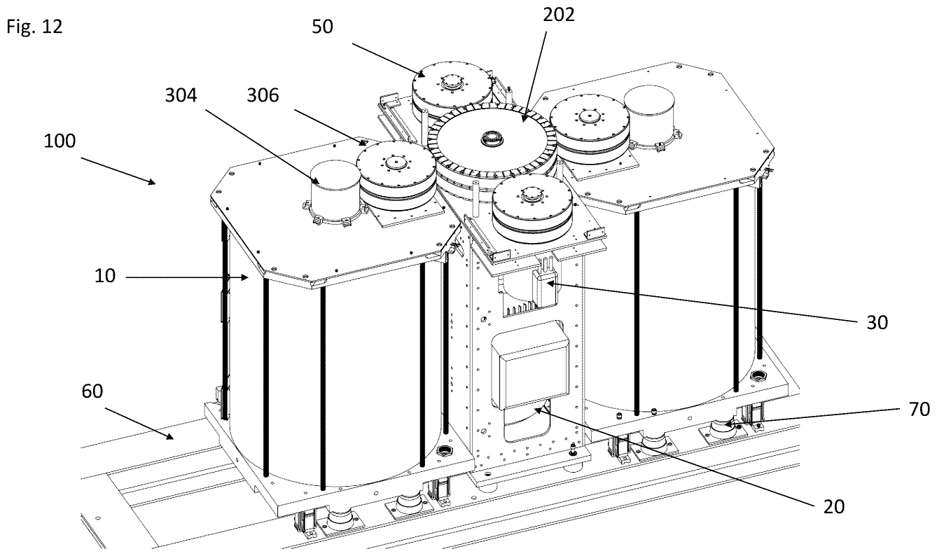

In yet a further embodiment, depicted in FIG. 12, the motor 20 may have a planetary gear set 202 (shown without the gear box wall 214, top plate 215, spindle 250, and cover 258) operably connected thereto, and the generator gear 50 and generator 30 may be driven by the ring gear 212. Mounted on the flywheel assembly 10 is a magnetic pinion gear 304, which is substantially similar to the sun gear 204. An intermediate gear 306, which is similar in construction to the planet gear 208 engages the ring gear 212 of the planetary gear set 202 and the magnetic pinion gear 304 to drive the magnetic pinion gear 304. Both the magnetic pinion gear 304 and the intermediate gear 306 may be enclosed on one or more covers not shown allowing for a vacuum to be achieved within the cover and reducing the windage of the pinion gear 304 and the intermediate gear 306. As can be seen in FIG. 12, the arrangement of the generators 30 and generator gears 50 on two transfer points 216 and the intermediate gears 306 on two further transfer points 216 (each 90 degrees from each other) is an example of one of the arrangements described above that reduces the length of the renewable energy generation system 100. As with all other gears described herein the generator gear 50 may be enclosed in a housing on which a vacuum may be drawn to reduce the effects of windage on the transfer of rotary motion from one component to the next.

A further aspect of the disclosure relates to reduction of energy losses during the long term storage of energy in the flywheel assemblies 10. When not being driven by the motor 20 or generating energy via the generator 30, the motor 20 and generator 30, which are not under vacuum represent a not insignificant source of friction and windage. In accordance with the disclosure either or both of the generator 30 or the motor 20 may be mounted on a movable plate. The movable plate is configured to move the motor 20 or the generator 30 either vertically or horizontally relative to the gear they magnetically interact with. Thus, in one example the generator gear 50 and generator move vertically relative to the planetary gear set 202. Once sufficient gap is achieved, the magnets 206 of the gears cease interacting with one another. Eventually the generator 30 will stop spinning, but regardless, once sufficient gap is achieved, the generator 30 stops being a drain on the mechanical energy stored in the flywheel of the flywheel assembly 10. In a similar manner the motor 20 may be moved vertically or horizontally to break the magnetic connection between the motor gear 200 and the planetary gear set 202. This removes the motor 20 from being a drain on the mechanical energy stored in the flywheel of the flywheel assembly.

Those of ordinary skill in the art will recognize that the systems and components described herein may be optimized for a given use. In one non-limiting implementation of the planetary gear set 202, the sun gear 204 has 16 magnets, the planet gear has 28 magnets, and the ring gear has 76 magnets resulting in a 4.75-1 gear ratio. Thus, employing for example a motor with a speed of 1800 RPM, a flywheel speed of 8550 RPM can be achieved.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of embodiments. Those skilled in the art will envision other modifications within the scope and spirit of the claims appended hereto.

What is claimed is:

1. A renewable energy generation system comprising:
a flywheel assembly including a flywheel configured for mechanical storage of energy;
a magnetic planetary gear set coupled to the flywheel assembly;
a motor operably connected to a magnetic motor gear, wherein the magnetic motor gear magnetically couples with a ring gear of the magnetic planetary gear set to drive the flywheel and convert electrical energy driving the motor into mechanical energy for storage in the flywheel.

2. The renewable energy generation system of claim 1, wherein the magnetic planetary gear set further includes at least one planet gear magnetically coupled to the ring gear.

3. The renewable energy generation system of claim 2, wherein the magnetic planetary gear set further includes a sun gear magnetically coupled to the planet gear.

4. The renewable energy generation system of claim 3, wherein each of the ring gear, at least one planet gear, and sun gear include two rows of magnets.

5. The renewable energy generation system of claim 3, wherein the sun gear further includes a magnetic lift bearing lifting the sun gear in a direction of a top plate of the ring gear to reduce a vertical load on the sun gear.

6. The renewable energy generation system of claim 5, wherein the magnetic lift bearing comprises a magnetic ring affixed to the sun gear and attracting the sun gear towards the top plate of the ring gear.

7. The renewable energy generation system of claim 6, wherein the sun gear further comprises at least one mechanical bearing, and wherein the magnetic lift bearing reduces a vertical load on the mechanical bearing.

8. The renewable energy generation system of claim 3, wherein the at least one planet gear further includes a magnetic levitating bearing lifting the planet gear away from a bottom plate of the planetary gear set to reduce a vertical load on the planetary gear.

9. The renewable energy generation system of claim 8, wherein the magnetic levitating bearing comprises a first magnetic ring secured to a shaft about which the at least one planet gear rotates and a second magnetic ring secured to the planet gear.

10. The renewable energy generation system of claim 9, wherein the first and second magnetic rings have a common polarity facing one another such that the first and second magnetic rings repel one another and lift the at least one planet gear relative to the shaft.

11. The renewable energy generation system of claim 10, wherein the at least one planet gear further comprises at least one mechanical bearing, and wherein the magnetic levitation bearing reduces a vertical load on the mechanical bearing.

12. The renewable energy generation system of claim 3, wherein the ring gear further includes a magnetic lift bearing lifting the ring gear in a direction of a top plate of the planetary gear set to reduce a vertical load on the sun gear.

13. The renewable energy generation system of claim 12, wherein the magnetic lift bearing includes two magnets arranged to attract each other.

14. The renewable energy generation system of claim 13, where a first of the two magnets is secured to a shaft of the ring gear and a second of the two magnets is secured to a cover enclosing the shaft, the cover configured to mate with a top plate of the planetary gear set.

15. The renewable energy generation system of claim 14, wherein the shaft extends from a spindle configured to mate with a top plate of the ring gear.

16. The renewable energy generation system of claim 15, wherein the ring gear further comprises at least one mechanical bearing mounted on the shaft extending from the spindle, and wherein the magnetic lift bearing reduces a vertical load on the mechanical bearing.

17. The renewable energy generation system of claim 1, further comprising a magnetic generator gear, wherein the magnetic generator gear magnetically couples with one of the ring gear or the motor gear.

18. The renewable energy generation system of claim 1, wherein the generator gear drives the generator to convert mechanical energy stored in the flywheel to electrical energy for application to a load.

19. The renewable energy generation system of claim 1, wherein the planetary gear set includes a plurality of transfer points, wherein each transfer point enables magnetic coupling of the ring gear with the motor gear or a generator gear.

20. The renewable energy generation system of claim 1, wherein one or more off the motor gear, planetary gear set, or generator gear are under vacuum, the vacuum reducing windage of each of the gears as they rotate.
